(19) United States
(12) Patent Application Publication
(10) Pub. No.: US 2012/0117089 A1
(43) Pub. Date: May 10, 2012

(54) BUSINESS INTELLIGENCE AND REPORT STORYBOARDING

(75) Inventors: Olivier Lionel Matrat, Redmond, WA (US); Thierry J. D'Hers, Redmond, WA (US); Amir M. Netz, Bellevue, WA (US); Stella Chan Rowlett, Redmond, WA (US); Riccardo E. Muti, Seattle, WA (US)

(73) Assignee: Microsoft Corporation, Redmond, WA (US)

(21) Appl. No.: 13/033,505

(22) Filed: Feb. 23, 2011

Related U.S. Application Data
(60) Provisional application No. 61/411,379, filed on Nov. 8, 2010.

(51) Int. Cl. G06F 17/30

(52) U.S. Cl. 707/752; 707/E17.009

(57) ABSTRACT

Embodiments are directed to organizing reporting data from various sources such as frames into a storyboard view with additional metadata that is specific to the storyboard and to sharing and/or exporting a storyboard sequence of reporting frames. In an embodiment, a computer system accesses various portions of reporting data. The reporting data includes source data, relevant data states and metadata describing properties of the associated report. The computer system organizes the reporting data into multiple reporting frames according to various organizing criteria. Each reporting frame is incorporated into a storyboard interface. The computer system also displays the storyboard interface which includes each of the reporting frames organized according the organizing criteria.

### CROSS-REFERENCE TO RELATED APPLICATIONS

This application claims priority to and the benefit of U.S. Provisional Application No. 61/411,379, entitled “Business Intelligence Storyboard”, which was filed on Nov. 8, 2010, and which is incorporated by reference in its entirety herein.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications are designed to display various different forms of data including reports. Reports may take in various sources of information and combine them into a document or form that is understandable to a human reader. As the amount of information included in such reports is steadily increasing, users are having an increasingly difficult time determining which information should be presented, and how that information should be presented to the reader. Complex decision processes in today's organizations typically use multiple different reports, pieced together and arranged in various forms in an attempt to help end users understand the rationales behind the various reports.

### BRIEF SUMMARY

Embodiments described herein are directed to organizing reporting data into a storyboard view and to exporting a storyboard sequence of reporting frames. In one embodiment, a computer system accesses various portions of reporting data. The reporting data includes source data, relevant data states and metadata describing properties of the associated report. The computer system organizes the reporting data into multiple reporting frames according to various organizing criteria. Each reporting frame is incorporated into a storyboard interface. The computer system also displays the storyboard interface which includes each of the reporting frames organized according the organizing criteria.

In another embodiment, a computer system accesses various portions of reporting data. The reporting data includes source data, relevant data states and metadata describing properties of the associated report. The computer system organizes the reporting data into multiple reporting frames according to various organizing criteria. Each reporting frame is incorporated into a storyboard interface. The computer system exports the storyboard to a user-specified target format. The frame sequence and corresponding frame information is preserved during exporting.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including organizing reporting data into a storyboard view and exporting a storyboard sequence of reporting frames.

FIG. 2 illustrates a flowchart of an example method for organizing reporting data into a storyboard view.

FIG. 3 illustrates a flowchart of an example method for exporting a storyboard sequence of reporting frames.

FIG. 4 illustrates a storyboard interface with different reporting frames.

### DETAILED DESCRIPTION

Embodiments described herein are directed to organizing reporting data into a storyboard view and to exporting a storyboard sequence of reporting frames. In one embodiment, a computer system accesses various portions of reporting data. The reporting data includes source data, relevant data states and metadata describing properties of the associated report. The computer system organizes the reporting data into multiple reporting frames according to various organizing criteria. Each reporting frame is incorporated into a storyboard interface. The computer system also displays the storyboard interface which includes each of the reporting frames organized according the organizing criteria.

In another embodiment, a computer system accesses various portions of reporting data. The reporting data includes source data, relevant data states and metadata describing properties of the associated report. The computer system organizes the reporting data into multiple reporting frames according to various organizing criteria. Each reporting frame is incorporated into a storyboard interface. The computer system exports the storyboard to a user-specified target format. The frame sequence and corresponding frame information is preserved during exporting.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry data or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks (e.g. cloud computing, cloud services and the like). In a distributed system environment, program modules may be located in both local and remote memory storage devices.

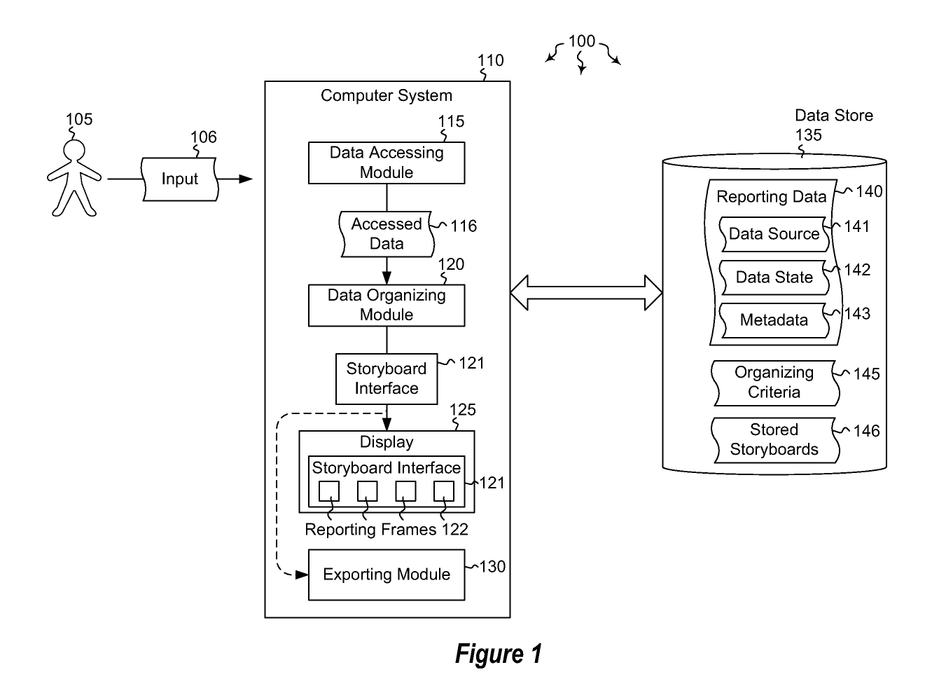

FIG. 1 illustrates a computer architecture 100 in which the principles of the present invention may be employed. Computer architecture 100 includes computer system 110. Computer system 110 includes various modules which may be used to perform various functions of the embodiments described herein. The computer system may be any type of computer including a local computer system, mobile computer system or distributed computer system (e.g. a cloud computer system). The computer system includes data accessing module 115. The data accessing module may access reporting data 140 stored in data store 135. The reporting data may include any type of data or information that can be compiled in a report. The data may include text, pictures, audio, video, documents, files or any other type of information.

The reporting data may itself include other types of data. For instance, the reporting data may include source data 141, data state 142 and metadata 143. The source data for a report may refer to servers, databases, queries, views, tables, names and/or definitions from which the report pulls data. The data state may indicate the current or former state(s) of the data. The data state may indicate whether the data has been modified or saved in different formats. The data report state may further refer to the values of data contained in the report, as well as any filters and/or sort orders applied by the report consumer to the report's data. This state may reflect the report consumer's “train of thoughts” and will be stored along with the report as part of a storyboard frame. The metadata may indicate various different properties about the data including storyboard frame rankings, page views, downloads, user annotations that describe the report and/or report state, a date indicating the time the data was created or last modified, a name indicating the creator or last modifier of the data, an indication of the data's owner, or other information about the data. The data accessing module may access this data and send it (as accessed data 116) to the data organizing module 120.

The data organizing module may be configured to organize the accessed data into a storyboard, or storyboard interface 121. The storyboard may include multiple different reporting frames 122. These frames may each include various different portions of reporting data (and/or portions of source data, data state and metadata). Each frame may be placed in a particular order by the data organizing module. The organizing module may access various organizing criteria 145 (which may be stored on data store 135, or locally on computer system 110) which it then uses to determine which portions of data appear on which reporting frames (or “slides” herein). The organizing module may also determine which order the slides appear in on the storyboard interface. Accordingly, large amounts of data may be organized automatically into various different slides, and put into a storyboard which is displayed to the user 105 on display 125. The storyboard may then be exported and stored (e.g. 146) in various different formats by exporting module 130.

Thus, in some embodiments, storyboard techniques may be used to provide guided analysis of business (or other) data which can streamline decision-making processes. Storyboards that involve business data or business intelligence may provide tools for assembling and organizing sets of business metrics, analyses and insights into visual collections (e.g. storyboard interface 121) that can be walked through in sequential order, thus helping capture and restitute both the source data (141), its various relevant states (142), and the dynamics of the reasoning behind business decisions (in metadata 143). Storyboards may be used to “tell the story” of a particular business behind and beyond the data. The storyboards may bring order and meaning to various types of business data.

User 105 may interact with a user interface, supplying inputs 106 for which the computer system provides outputs. The storyboard-like interface 121 may be a customizable user interface for creating, organizing, navigating and sorting individual business views. In some cases, the storyboard interface may be used in various other software programs, including collaboration software that allows multiple users to view and edit data documents. The storyboard may be built on a conceptual model that defines the storyboard, individual reporting frames 122 that make up the storyboard, and an indication of how the reporting frames relate to one another and to the business views providing the contents of the storyboard.

The storyboard interface may be designed to look and feel like a movie strip, thereby conveying the notion of an ordered set of frames that are intended to be walked through in sequence. Each frame may represent a business view (which, at least in some cases, corresponds to a static or dynamic report with state, query, or a combination thereof). A static snapshot representative of the business view may be displayed on the storyboard along with the snapshot's sequence number. In some embodiments, clicking the snapshot may launch the actual view. Using the storyboard interface, a user may create new storyboards, add or delete frames from existing storyboards, edit existing frame information within storyboards and re-order the sequence of frames within a storyboard. Storyboards may be specific to a particular user, and any individual user can have multiple storyboards. Individual frames may be representative of various business reports, which may or may not originate from the same application or data source. This user interface may be designed to work both in client/server and Web (thin) client environments.

In some embodiments, the contents of a storyboard may be exported to various target formats, such as word processing documents, spreadsheet documents, presentations or other formats. The frame sequence and any associated information (e.g. author, time stamp, etc.) is preserved when exporting. In some cases, exporting a storyboard which comprises five frames to a presentation document format results in a presentation with five slides (one per frame) plus an automatically-generated summary slide. As such, the data is not locked in one particular storyboard format. The storyboard may be enriched in various ways including adding slides, annotations or animations in a presentation, adding special formatting in a word processing document, or defining custom calculations, visualizations and automation macros in a spreadsheet document.

A common set of editing and querying application programming interfaces (APIs) may be provided which support basic C.R.U.D. (Create Read Update Delete) operations at the storyboard and frame levels. Add, remove and count methods, as well as item properties may be provided both for the storyboard, as well as for the individual frames. The APIs may include server and Web service APIs for intranet-based and internet based applications. The editing and querying APIs may be used to consume data from the storyboards and/or develop custom front-ends. The APIs may also be extended with custom connectors used to connect to additional reporting data sources and/or write additional export modules.

Each storyboard may include various items including a unique identifier and/or name, a timestamp corresponding to the last update date and time, a reference to the storyboard's parent folder, and/or a field identifying the creator/owner of the storyboard. Each frame of the storyboard may similarly include items such as the following: a unique identifier and/or name, a timestamp corresponding to the last update date and time, a reference to the storyboard that the frame belongs to, a field identifying the creator/owner of the storyboard, a field holding comments associated with the frame, a reference to the view (a.k.a. reporting data) that the frame is representing and a sequence number that is unique within the parent storyboard.

A business view may be referenced by one or more individual storyboard frames. The business view may store metadata about the view itself including a unique identifier and/or name, a timestamp corresponding to the last update date and time, a reference to the view's underlying data source, a reference to the view's underlying query, state information (e.g. filters, sort orders, drill states) associated with the view, and data associated with the view. For example, the business view may incorporate a “Sales breakdown by Product Line” report along with a particular state (data set plus current filters and sort orders) in both a “Sales” storyboard and a “Marketing” storyboard. A thumbnail may store information about images that are associated with each view in the context of individual frames and storyboards, including a unique identifier and/or name, a timestamp corresponding to the last update date and time, the image data and/or a reference to it (e.g. a uniform resource locator (URL)), a reference to the business view that the thumbnail corresponds to, and/or a reference to the frame that the thumbnail corresponds to.

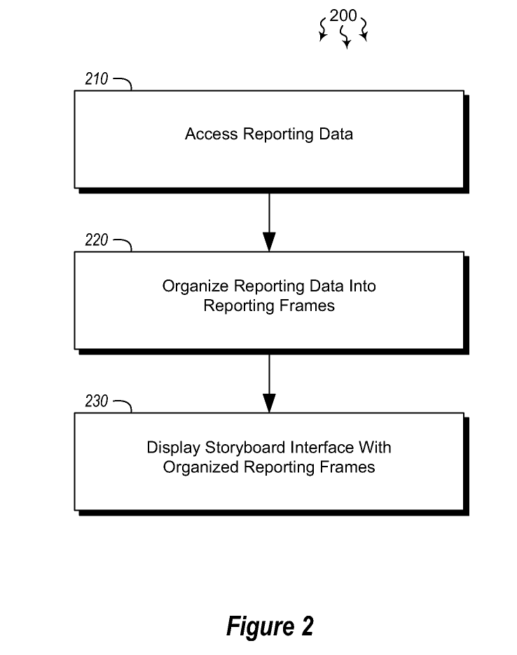

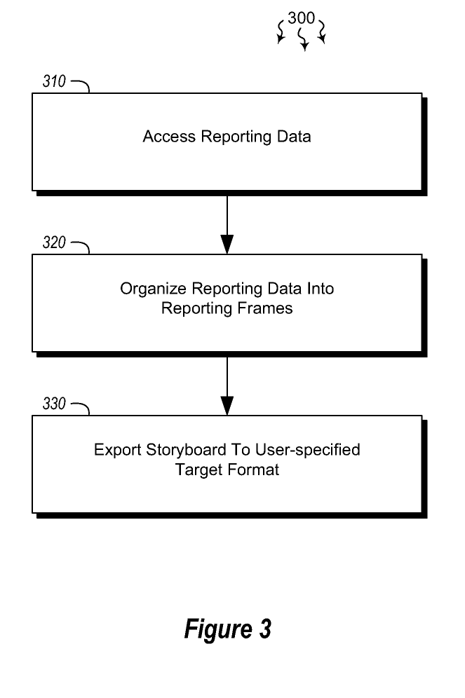

A persistence API may also be provided which is used to serialize and persist information about the storyboard's information to disk, and read it back. The persistence API can support a variety of standard storage modes including traditional operating system file systems, relational databases, or file collaboration applications. The persistence APIs may have extension points for supporting alternate storage formats. In the operating system file system, various entities of the storyboard (e.g. frames, views and thumbnails) may be represented by files and folders. In a relational database, the various entities of the storyboard may be represented by a relational model where storyboards, frames, views and thumbnails are relationally stored as columns, tables and relationships. In a collaboration application, storyboard information and metadata may be stored as files which are then accessible by other collaboration application users. These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for organizing reporting data into a storyboard view. The method 200 will now be described with frequent reference to the components and data of environment 100.

Method 200 includes an act of an act of accessing one or more portions of reporting data, wherein the reporting data includes source data, relevant data states and metadata describing properties of the associated report (act 210). For example, data accessing module of computer system 110 may access various portions of reporting data 140 that is to be included as part of a reporting frame and, in turn, part of a storyboard interface. The reporting data may include any type of data including source data 141, data state information 142, metadata 143, or other types of data. All or portions of the data may be displayed in various different reporting frames 122 (or simply frames).

Method 200 includes an act of organizing the reporting data into a plurality of reporting frames according to one or more organizing criteria, wherein each reporting frame is incorporated into a storyboard interface (act 220). For example, data organizing module 120 may organize the data 116 accessed by module 115. The data organizing module may organize the reporting data into one or more frames according to organizing criteria 145. The criteria may include user-specified options indicating the proper order for the frames to appear in, data rankings for different frames, layout parameters for the reporting data, associations between the data (such that like data is displayed in a like manner), original data organization features, and other criteria. The user may edit existing criteria, may add new criteria, or may override settings indicated by the criteria.

The individual frames of a storyboard sequence may include any of the following: a name, a unique identifier, a timestamp, metadata, a report definition and author information. The storyboard interface may allow users to add reporting frames that represent different business or other types of reports. The storyboard interface may be interactive, allowing users to dynamically add, delete and edit reporting frames while the frames are being displayed in the display 125. As indicated above, the storyboard and its component frames, views and thumbnails may be stored in data store 135. Each storyboard, frame, view and thumbnail may be stored as separate files, each of which is associated to the other frames views and thumbnails that are part of the same storyboard.

Method 200 includes an act of displaying the storyboard interface, wherein the interface includes each of the reporting frames organized according the one or more organizing criteria (act 230). For example, display 125 of computer system 110 may display the storyboard, where each of the reporting frames that include the reporting data is presented according to the organizing criteria. The various reporting frames may show multiple different views of the same data. The data may be in chart form in one frame, while being in table form in another. In some cases, various portions of the metadata 143 associated with the reporting data 140 are displayed in different parts of the reporting frame. For example, a data ranking may be displayed in the corner of each frame.

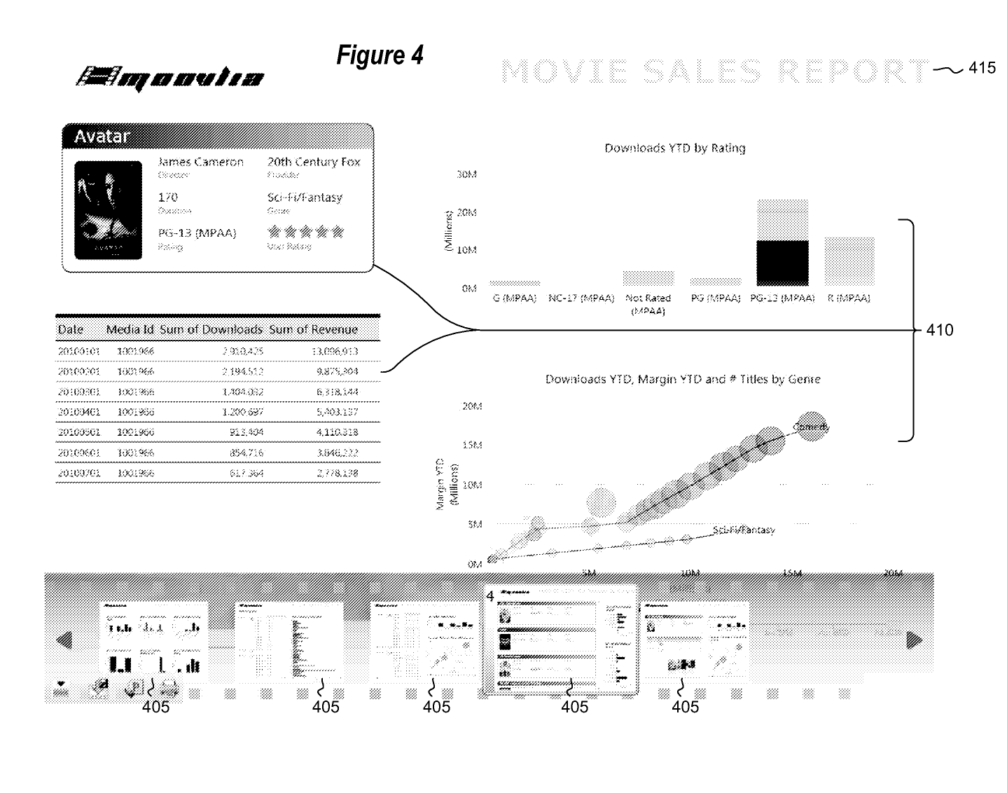

In some embodiments, the storyboard interface may show a static snapshot of each reporting frame. For instance, as shown in FIG. 4, multiple frame snapshots 405 may be shown in the bottom of the storyboard interface. Specifically, in FIG. 4, five static snapshots are shown. The fourth frame is slightly enlarged as it has been selected by a user. In some cases, the selected frame is displayed in large view in the storyboard interface. In this case, the selected frame has only been highlighted, and has not been enlarged. In the storyboard interface shown in FIG. 4, a user may select different frames, add new frames, delete existing frames, modify frame data or frame sequence, or otherwise interact with the frames.

The storyboard interface of FIG. 4 further illustrates the types of information that may be shown. For instance, the storyboard may show a movie sales report 415. The movie sales report may include multiple different pictures, charts, graphs or other items of information 410. Each of these items may be edited by the user. Each frame 405 may show different portions of information, organized in different fashions. The user may lay out data from different data sources in a logical, ordered manner, which may be viewed in a storyboard form.

The generated storyboard may be shared with other computer users. The storyboard itself may be stored and shared as a single unit. Still further, each component part of the storyboard may be individually shared and stored by a user. The users may view and collaborate on a single storyboard, editing and saving changes as edits are made. The storyboard may be exported to any of a variety of different target formats including word processing documents, spreadsheet documents and presentation documents. When the storyboard is exported to any of the various formats, the frame sequence and other corresponding frame information is preserved during exporting.

FIG. 3 illustrates a flowchart of a method 300 for exporting a storyboard sequence of reporting frames. The method 300 will now be described with frequent reference to the components and data of environment 100.

Method 300 includes an act of accessing one or more portions of reporting data, wherein the reporting data includes source data, relevant data states and metadata describing properties of the associated report (act 310). For example, data accessing module 115 may access reporting data 140. The reporting data may be organized into reporting frames 122 based on various different organizing criteria (act 320). These criteria may be specific to the type of data, specific to the user or organization, specific to the software program into which the storyboard slides are to be exported, or may be generally applied to all frames.

The data may be exported by exporting module 130 to a user-specified target format. The frame sequence and corresponding frame information is preserved during exporting (act 330). The storyboard may be exported as a whole, or in portions. Each component frame, view and thumbnail may be separately exported and saved in a variety of different data formats. Different APIs may be provided for storing the storyboard in the various different target formats. Regardless of whether the data is exported and/or stored, the storyboard may be displayed in display 125 according to the frame organizing criteria.

Accordingly, methods, systems and computer program products are provided which organize reporting data into storyboard views. The storyboards may be edited, exported and saved for later access. The storyboards may provide users with an efficient way to view and analyze data, while maintaining the organizational structure of the original data.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including at least one processor and a memory, in a computer networking environment including a plurality of computing systems, a computer-implemented method for organizing reporting data into a storyboard view, the method comprising:
an act of accessing one or more portions of reporting data, wherein the reporting data includes source data, relevant data states and metadata describing properties of the associated report;
an act of organizing the reporting data into a plurality of reporting frames according to one or more organizing criteria, wherein each reporting frame is incorporated into a storyboard interface; and
an act of displaying the storyboard interface, wherein the interface includes each of the reporting frames organized according the one or more organizing criteria.

2. The method of claim 1, wherein the reporting frames include one or more of the following: a name, a unique identifier, a timestamp, metadata, a report definition, a reference to a report definition and author information.

3. The method of claim 1, wherein the storyboard comprises a sequence of individual reporting frames.

4. The method of claim 1, further comprising sharing the storyboard with a plurality of other computer users.

5. The method of claim 4, wherein the storyboard is shared over at least one of the following: the internet, an intranet, a file-collaboration application and a file-sharing application.

6. The method of claim 1, wherein the storyboard interface allows users to add different reporting frames that represent at least one of the following: different reports with their state, the same report in different states, or a combination of different reports with their state and the same report in different states.

7. The method of claim 1, wherein the storyboard interface is interactive, allowing users to dynamically add, delete and edit reporting frames.

8. The method of claim 1, wherein the storyboard interface is configured to show multiple different views of the same or different data from the same or different source reports.

9. The method of claim 1, wherein one or more portions of metadata are shown in different parts of the reporting frame, and wherein the metadata comprises at least one of reporting frame author, reporting frame sequence and reporting frame annotations.

10. The method of claim 1, wherein the storyboard interface shows a static snapshot of each reporting frame that was taken at one of the following times: at the time the frame was added to the storyboard, or at the time the frame was last edited.

11. The method of claim 1, further comprising exporting the storyboard to a target format.

12. The method of claim 10, wherein frame sequence and corresponding frame information is preserved during exporting.

13. A computer program product for implementing a method for exporting a storyboard sequence of reporting frames, the computer program product comprising one or more computer-readable storage media having stored thereon computer-executable instructions that, when executed by one or more processors of the computing system, cause the computing system to perform the method, the method comprising:
an act of accessing one or more portions of reporting data, wherein the reporting data includes source data, relevant data states and metadata describing properties of the associated report;
an act of organizing the reporting data into a plurality of reporting frames according to one or more organizing criteria, wherein each reporting frame is incorporated into a storyboard; and
an act of exporting the storyboard to a user-specified target format, wherein frame sequence and corresponding frame information is preserved during exporting.

14. The computer program product of claim 13, further comprising displaying the storyboard interface, wherein the interface includes each of the reporting frames organized according to one or more organizing criteria.

15. The computer program product of claim 13, wherein one or more application programming interfaces (API's) are provided for storing the storyboard in the various different target formats.

16. The computer program product of claim 13, wherein each component of each reporting frame is separately storable and separately accessible.

17. The computer program product of claim 16, wherein each of the reporting frame components is stored and represented in a relational model.

18. A computer system comprising the following:
one or more processors;
system memory;
one or more computer-readable storage media having stored thereon computer-executable instructions that, when executed by the one or more processors, causes the computing system to perform a method for organizing reporting data into a storyboard view, the method comprising the following:
an act of accessing one or more portions of reporting data, wherein the reporting data includes source data, relevant data states and metadata describing properties of the associated report;
an act of organizing the reporting data into a plurality of reporting frames according to one or more organizing criteria, wherein each reporting frame is incorporated into a storyboard;
an act of exporting the storyboard to a user-specified target format, wherein frame sequence and corresponding frame information is preserved during exporting; and
displaying the storyboard interface, wherein the interface includes each of the reporting frames organized according the one or more organizing criteria.

19. The system of claim 18, wherein the storyboard interface allows users to add reporting frames that represent different reports.

20. The system of claim 18, wherein the storyboard interface is interactive, allowing users to dynamically add, delete and edit reporting frames.
